(19) United States
(12) Patent Application Publication
(10) Pub. No.: US 2006/0137275 A1
(43) Pub. Date: Jun. 29, 2006

(54) Safety device

(76) Inventors: Eran Vashdi, Hertzelia (IL); Michael Dan-Harel, Hod Ha'Sharon (IL)

Correspondence Address: Angenehm Law Firm, Ltd., P.O. Box 48755, Coon Rapids, MN, 55448-0755, US

(21) Appl. No.: 11/302,797

(22) Filed: Dec. 14, 2005

Related U.S. Application Data
(60) Provisional application No. 60/636,932, filed on Dec. 17, 2004.

(51) Int. Cl. E06B 3/70

(52) U.S. Cl. 52/455

(57) ABSTRACT

The present invention provides a safety device for a door adapted to prevent the door from being slammed. The device is installed within a recess provided in the door and comprises a housing adapted to be inserted within the recess, a tongue provided in the housing wherein the tongue is adapted to move between a first position in which it partially protrudes outwardly from the recess and a second position in which it is fully inserted within the recess. The tongue is in the first position when the door is open and is in a second position when the door is closed. When the door is unintentionally slammed into the jamb, the tongue collides in the jamb preventing the door from being fully closed and when the door is intentionally closed, the tongue is withdrawn to within the recess using the door handle so as to allow full closure of the door upon the jamb.

### FIELD OF THE INVENTION

The present invention claims priority from U.S. provisional patent application Ser. No. 60/636,932 filed on 17 Dec. 2004. The present invention relates to safety devices. More particularly, the present invention relates to a safety device for a door so as to prevent the door from unintentionally slamming on body parts, especially fingers of children.

### BACKGROUND OF THE INVENTION

It is known that most accidents occur at the home vicinity. One of the dangers at home is door slamming. There are many cases in which a door slams on fingers, especially of small children, while inflicting severe damage to the fingers.

There is a need to provide a mechanism that provides safety from hazards of slamming doors so as to prevent unnecessary accidents that involve door slam.

### SUMMARY OF THE INVENTION

It is an object of the present invention to provide safety device that prevents a door from slamming.

It is another object of the present invention to provide a safety device that is incorporated in a door so as to prevent its unintentional slam.

It is an additional object of the present invention to provide a safety device that is an add-on device that is adapted to be installed in an existing door; however, the device can be incorporated within the door during its manufacturing.

Therefore, it is provided in accordance with a preferred embodiment of the present invention to provide a safety device adapted to be installed within a recess provided in a door that is closed into a jamb using a handle, said safety device comprising:
a housing adapted to be inserted within the recess;
a tongue provided in said housing wherein said tongue is adapted to move between a first position in which said tongue partially protrudes outwardly from the recess and a second position in which said tongue is fully inserted within the recess, and wherein said tongue is in the first position when the door is open and is in a second position when the door is closed;
a resilient element provided within said housing wherein said resilient element is adapted to outwardly push said tongue when there is no force applied onto said tongue;
a lever associating said tongue to the door's handle;
whereby when the door is unintentionally slammed into the jamb, said tongue collides in the jamb preventing the door from being fully closed and when the door is intentionally closed, said tongue is withdrawn to within the recess using the door handle so as to allow full closure of the door upon the jamb.

Furthermore and in accordance with a preferred embodiment of the present invention, said tongue is provided with at least one track adapted to limit the movement of the tongue.

Furthermore and in accordance with a preferred embodiment of the present invention, said housing is provided with at least one pin inserted laterally within said at least one track and wherein said at least one track is adapted to bound the movement of the tongue.

Furthermore and in accordance with a preferred embodiment of the present invention, said at least one pin is connected to said housing by at least one screw.

Furthermore and in accordance with a preferred embodiment of the present invention, a resilient element is provided about at least one of said at least one pin, wherein said resilient element is adapted to soften the collision of said tongue with the jamb.

Furthermore and in accordance with a preferred embodiment of the present invention, said resilient element is a spring.

Furthermore and in accordance with a preferred embodiment of the present invention, said resilient element is a spring provided about a portion of said lever and between said housing and said tongue.

Furthermore and in accordance with a preferred embodiment of the present invention, said lever is attached to said tongue through a hole provided in said tongue.

Furthermore and in accordance with a preferred embodiment of the present invention, housing is provided with lateral extending wing-like members adapted to prevent the housing from being fully inserted to within a hollow in the door.

Furthermore and in accordance with a preferred embodiment of the present invention, said wing-like members are provided with screw adapted to be screwed to the door.

Furthermore and in accordance with a preferred embodiment of the present invention, the recess is provided in an upper portion of the door.

Furthermore and in accordance with a preferred embodiment of the present invention, the recess is provided substantially in a lateral middle of said upper portion.

Furthermore and in accordance with a preferred embodiment of the present invention, the doors handle is a door knob.

Furthermore and in accordance with a preferred embodiment of the present invention, said lever passes through a hole in said housing.

Additionally and in accordance with a preferred embodiment of the present invention, said tongue is associated with a resilient material adapted to soften the collision of the tongue with the jamb.

### BRIEF DESCRIPTION OF THE FIGURES

In order to better understand the present invention and appreciate its practical applications, the following Figures are attached and referenced herein. Like components are denoted by like reference numerals.

It should be noted that the figures are given as examples and preferred embodiments only and in no way limit the scope of the present invention as defined in the appending Description and Claims.

FIG. 1a illustrates a frontal view (partially cross sectioned) of a safety device provided in a door in accordance with a preferred embodiment of the present invention, in a position wherein the door is closed.

FIG. 1b illustrates the safety device shown in FIG. 1a, in a position wherein the door is open.

FIG. 2 illustrates a frontal view of the safety device shown in FIG. 1.

FIG. 3a illustrates an inner mechanism of a safety device in accordance with a preferred embodiment of the present invention.

FIG. 3b illustrates the inner mechanism shown in FIG. 3b, in a position correspond to a closed door.

FIG. 4 illustrates an upper view of a safety device in accordance with another preferred embodiment of the present invention.

### DETAILED DESCRIPTION OF THE INVENTION AND FIGURES

The present invention provides a unique and new safety device adapted to be installed in the upper portion of the door wherein the device prevents the door from being slammed into its jamb from its open state. Slamming of doors is considered to be one of the hazards especially for children in the vicinity of their home since the door slammed on its lamb can act as a guillotine. There are many reports on severe incisions or partially cuts in fingers especially in children caused by a slam of a door. The safety device of the present invention is adapted to prevent this situation while it can be installed in the door when the door is being manufactured or can be provided as an add-on device that can be installed in an existing door.

The safety device in accordance with one aspect of the present invention is adapted to be installed within a swinging door that is closed on a jamb having a header. The device is provided within a recess formed in the upper portion of the door; the portion that is directed towards the header. The safety device comprises a tongue provided within the recess. The tongue moves between a first position in which it partially protrudes outwardly from the recess and a second position in which it is fully inserted within the recess. The tongue is in the first position, partially protrudes, when the door is open and is in a second position, withdrawn to within the recess when the door is closed. When the door is unintentionally slammed, the tongue collides in the header of the jamb preventing the door from being fully closed and when the door is intentionally closed, the tongue is withdrawn to within the recess so as to allow full closure of the door upon the jamb.

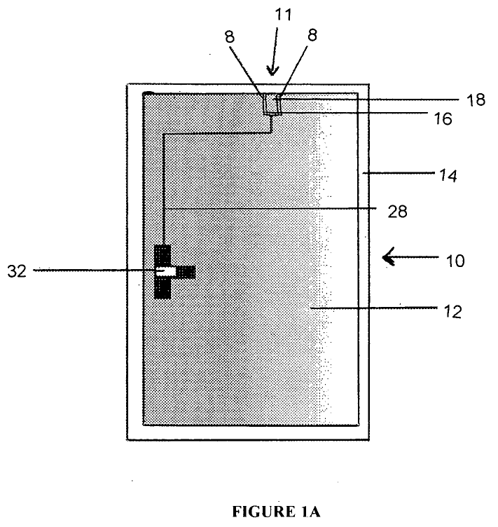

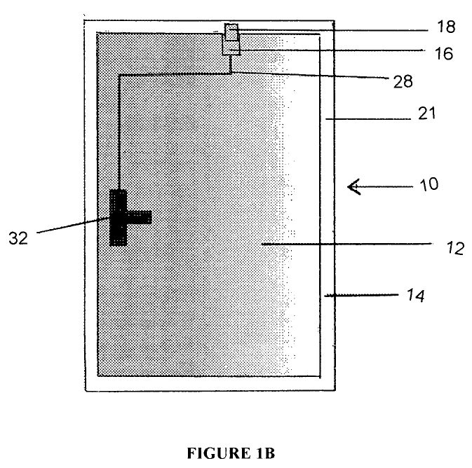

Reference is now made to FIGS. 1a and 1b illustrating a frontal view (partially cross sectioned) of a safety device provided in a door in accordance with a preferred embodiment of the present invention, in a position in which the door is closed and open, respectively. A standard swinging door 10 is usually provided with two adjacently adhered frames, a first frame 12 that is inserted within the smaller portion of a door's jamb (the jamb can be seen in FIGS. 1a and b) and a second frame 14 that is slightly larger and has a longer circumference than first frame 12. A recess 16 is preferably provided in the upper portion of door 10 while a safety device 11 in accordance with the present invention is mounted within recess 16. Safety device 11 comprises a housing that is adjacent to the recess's walls and a tongue 18 that is provided within the housing in recess 16. The housing is suspended within recess 16 by two wing-like members 8 that are provided in the upper portion of the mechanism and are outwardly and laterally protruding from recess 16.

When tongue 18 protrudes from recess 16 as shown in FIG. 1b, the door cannot be totally slammed. The tongue prevents first frame 12 from being fully slammed since it collides with the header of the door (the header is not shown). FIG. 1b illustrates a situation in which tongue 18 protrudes so as to prevent door 10 from being closed. When tongue 18 is withdrawn to within recess 16 as shown in FIG. 1a, door 10 is being closed.

A lever 26 connects safety device 11 with the door's handle 32 in order to withdraw tongue 18 to within recess 16 and allow an intended and undisturbed closure of door 10.

It should be noted that the positioning of the device relative to the distance from the lateral edges of the door is important. As the device is closer to the edge wherein the door hinges are provided, the more the effectiveness of the device. It is preferable in accordance with a preferred embodiment of the present invention to install the device substantially in the middle of the door's upper edge. In case, the device is installed distant of the hinges an closer to the edge where the door's handle is provided, an additional artificial spacer will have to be installed in the jamb.

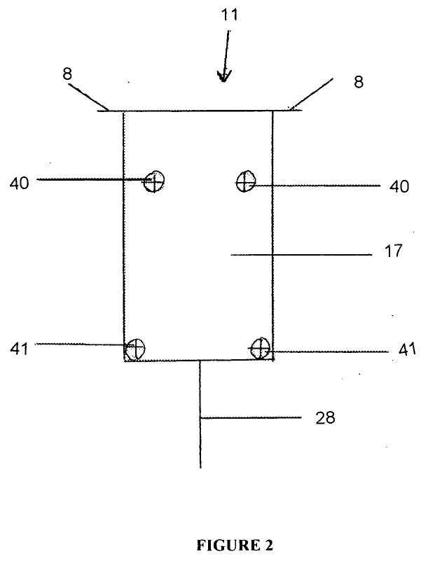

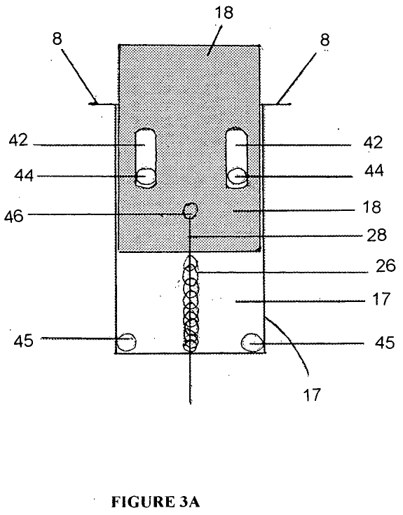

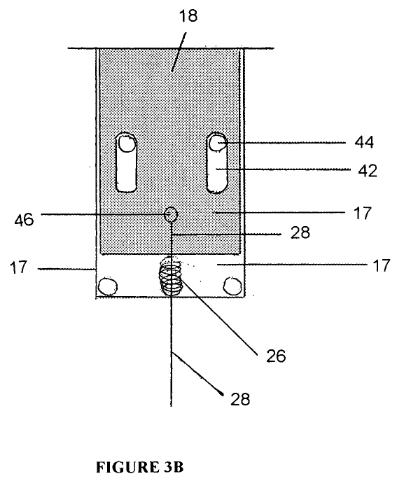

Reference is now made to FIG. 2 illustrating a frontal view of the safety device shown in FIG. 1. Safety device 11 comprises a housing 17 adapted to accommodate the tongue shown in FIGS. 1a and 1b (details of the tongue will be shown in FIGS. 3a and b which is a cross sectional view). As mentioned herein before, two wing-like members 8 are provided in the upper portion of safety device 11 and are outwardly and laterally protruding from the recess in the door and the lateral boundary of housing 17. Members 17 are adapted to prevent safety device 11 from falling down into hollow in the door and act as flanges. Housing 17 is preferably provided with two upper screws 40 and two lower screws 41 which role will be explained herein after.

A portion of lever 28 that connects safety mechanism 11 to the door handle (not shown in FIG. 2) is shown also.

Reference is now made to FIGS. 3a and 3b illustrating an inner mechanism of a safety device in accordance with a preferred embodiment of the present invention, when the door is open and closed, respectively. Tongue 18 is provided preferably with two tracks 42 adapted to limit the movement of the tongue to a predetermined extent and a predetermined direction—outwardly of housing 17 and inwardly to within housing 17. Two pins 44 that are passing through tracks 42 and are connected to both sides of housing 17 by screws 40 are adapted to stop the movement of tongue 18 in an outward position as seen in FIG. 3a and inward position as shown in FIG. 3b. Tracks 42 are traveling along pins 44.

Lever 28 is attached to tongue 18 through a hole 46 that is provided in the tongue. A spring 26 is provided about lever 28 in the portion of the lever that resides within housing 17 between tongue 18 and the bottom portion of the housing, where lever 28 passes and extend to the door's handle. Spring 26 is armed when the door is closed (shown in FIG. 3b) and is released when the door is open (shown in FIG. 3a). When the door is opened and the jamb is not limiting the tongue 18 to within housing 17, which is fully submerged within the door, tongue 18 will be automatically pushed outwardly from housing 17 by the force of armed spring 26. By this, when ever the door is open, the tongue will be outwardly protruded, preventing the door from being inserted to within the frame of the jamb. If the door is unintentionally slammed or closed, the tongue will collide into the header of the jamb while preventing the door from reaching a fully closed position. The safety mechanism prevents any unintentional closure of the door.

When the door is intentionally closed, tongue 18 should be withdrawn to within housing 17. When the door's handle is being downwardly pushed in order to close the door, lever 26 is pulled so as to withdraw tongue 18 into housing 17. If a door knob is used, the rotational movement of the knob will also cause lever 26 to pull tongue 18 to within housing 17.

The device as explained herein is mechanically operated, however, the device can be electrically activated or in any other way without limiting the scope of the present invention. If the use is of an electrical engine, it will be activated instead of the connection to the door's handle.

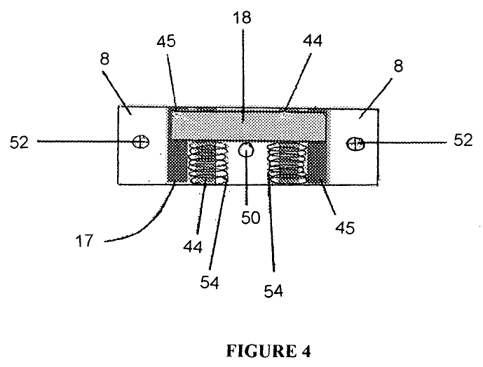

Reference is now made to FIG. 4 illustrating an upper view of a safety device in accordance with another preferred embodiment of the present invention. Most of the elements comprising safety device 11 are shown in the embodiment in FIG. 4. As mentioned herein before, tongue 18 is shown while pins 44 are passing through it to limit the movement of the tongue to a predetermined extent. Pins 45 are positioned in a portion of the housing where tongue 18 is not moving to. Pins 45 are held by screws 41 shown in FIG. 2. Lever 26 (not shown in FIG. 4) passes through a hole 50 provided in housing 17. Members 8 are shown to be connected to the door by screws 52.

Optionally and in accordance with the embodiment shown in FIG. 4, tongue 18 has a width that is smaller that the corresponding width of housing 17. A resilient element, preferably springs 54, are provided about pins 44 at one side of tongue 18 in the housing. Springs 54 are adapted to soften the collision of tongue 18 when it is protruded and collides with the jamb so as to prevent damage to the jamb.

Optionally, the tongue in the embodiment shown herein before can be coated with a resilient material such as a polymer also to prevent harsh colliding of the tongue onto the header of the jamb. Both cases are provided as examples and by no way limit the scope of the present invention.

It should be mentioned that it is optional to provide a safety device that is modular and can be removed at any desired time without difficulty.

Optionally, the door knob can be provided with an additional knob that is connected to the lever and has to be pushed when the door is intentionally closed in order to pull the tongue of the safety device to within the housing in the recess.

The device can be associated also with sensors of proximity that will be installed in the door in order to facilitate its sensitivity. The device can be operated when the sensor gives an order that an object is close to the door in less than a predetermined distance.

It should be mentioned that the safety device can be installed in another position of the door rather than the upper position.

It should be clear that the description of the embodiments and attached Figures set forth in this specification serves only for a better understanding of the invention, without limiting its scope as covered by the following Claims.

It should also be clear that a person skilled in the art, after reading the present specification can make adjustments or amendments to the attached Figures and above described embodiments that would still be covered by the following Claims.

1. A safety device adapted to be installed within a recess provided in a door that is closed into a jamb using a handle, said safety device comprising:
a housing adapted to be inserted within the recess;
a tongue provided in said housing wherein said tongue is adapted to move between a first position in which said tongue partially protrudes outwardly from the recess and a second position in which said tongue is fully inserted within the recess, and wherein said tongue is in the first position when the door is open and is in a second position when the door is closed;
a resilient element provided within said housing wherein said resilient element is adapted to outwardly push said tongue when there is no force applied onto said tongue;
a lever associating said tongue to the door's handle;
whereby when the door is unintentionally slammed into the jamb, said tongue collides in the jamb preventing the door from being fully closed and when the door is intentionally closed, said tongue is withdrawn to within the recess using the door handle so as to allow full closure of the door upon the jamb.

2. The safety device as claimed in claim 1, wherein said tongue is provided with at least one track adapted to limit the movement of the tongue.

3. The safety device as claimed in claim 2, wherein said housing is provided with at least one pin inserted laterally within said at least one track and wherein said at least one track is adapted to bound the movement of the tongue.

4. The safety device as claimed in claim 3 wherein said at least one pin is connected to said housing by at least one screw.

5. The safety device as claimed in claim 3, wherein a resilient element is provided about at least one of said at least one pin, wherein said resilient element is adapted to soften the collision of said tongue with the jamb.

6. The safety device as claimed in claim 5, wherein said resilient element is a spring.

7. The safety device as claimed in claim 1, wherein said resilient element is a spring provided about a portion of said lever and between said housing and said tongue.

8. The safety device as claimed in claim 1, wherein said lever is attached to said tongue through a hole provided in said tongue.

9. The safety device as claimed in claim 1, said housing is provided with lateral extending wing-like members adapted to prevent the housing from being fully inserted to within a hollow in the door.

10. The safety device as claimed in claim 9, wherein said wing-like members are provided with screw adapted to be screwed to the door.

11. The safety device as claimed in claim 1, wherein the recess is provided in an upper portion of the door.

12. The safety device as claimed in claim 11, wherein the recess is provided substantially in a lateral middle of said upper portion.

13. The safety device as claimed in claim, 1 wherein the doors handle is a door knob.

14. The safety device as claimed in claim 1, wherein said lever passes through a hole in said housing.

15. The safety device as claimed in claim 1, wherein said tongue is associated with a resilient material adapted to soften the collision of the tongue with the jamb.
